(19) United States
(12) Patent Application Publication
(10) Pub. No.: US 2024/0383175 A1
(43) Pub. Date: Nov. 21, 2024

(54) COMPOSITE MATERIAL AND METHOD FOR PRODUCING COMPOSITE MATERIAL STRUCTURE BODY

(71) Applicant: Murata Manufacturing Co., Ltd., Nagaokakyo-shi (JP)

(72) Inventors: Masanori ABE, Nagaokakyo-shi (JP); Akari SEKO, Nagaokakyo-shi (JP)

(21) Appl. No.: 18/785,689

(22) Filed: Jul. 26, 2024

Related U.S. Application Data
(63) Continuation of application No. PCT/JP2022/046433, filed on Dec. 16, 2022.

(30) Foreign Application Priority Data
Feb. 2, 2022 (JP) 2022-014920

(51) Int. Cl. B29C 41/08; B29C 41/00; B29C 41/22; B29C 41/46; B29K 33/00; B29K 105/16; B29K 509/04

(52) U.S. Cl. CPC B29C 41/08; B29C 41/003; B29C 41/22; B29C 41/46; B29K 2033/00; B29K 2105/16; B29K 2509/04; B29K 2995/0005

(57) ABSTRACT

A composite material that includes: particles of a two-dimensional material having one or plural layers; and an anionic resin material. The one or plural layers includes a layer body represented by: MₘXₙ, wherein M is at least one metal of Group 3, 4, 5, 6, or 7, X is a carbon atom, a nitrogen atom, or a combination thereof, n is 1 to 4, and m is more than n but not more than 5, and a modifier or terminal T exists on a surface of the layer body, wherein T is at least one of a hydroxyl group, a fluorine atom, a chlorine atom, an oxygen atom, and a hydrogen atom. A ratio of the particles of the two-dimensional material to a total of the particles of the two-dimensional material and a solid content of the resin material in the composite material is 50% to 99.9% by mass.

### CROSS REFERENCE TO RELATED APPLICATIONS

The present application is a continuation of International application No. PCT/JP2022/046433, filed Dec. 16, 2022, which claims priority to Japanese Patent Application No. 2022-014920, filed Feb. 2, 2022, the entire contents of each of which are incorporated herein by reference.

### TECHNICAL FIELD

The present disclosure relates to a composite material, more specifically, a composite (composite) material containing inorganic particles and a resin material, and a method for producing a composite material structure body.

### BACKGROUND ART

In recent years, MXene has been attracting attention as a new material having conductivity. MXene is a type of so-called two-dimensional material, and more specifically, as will be described later, MXene is a two-dimensional material (layered material) in the form of one or plural layers. In general, MXene is in the form of particles (which can include powders, flakes, nanosheets, and the like) of such a two-dimensional material (layered material).

In the related art, a composite material of MXene and a resin material (polymer material) have been known. For example, Non Patent Literature 1 describes a composite material in which MXene is filled in polyurethane by applying an emulsion method.

Non Patent Literature 1: Weiqiang Zhi, et al., “Study of MXene-filled polyurethane nanocomposites prepared via an emulsion method”, Composites Science and Technology, 2018, vol.168, pp.404-411

### SUMMARY OF THE DISCLOSURE

It is known that physical properties of an object (for example, a membrane) formed only of MXene change with time (typically, conductivity decreases over time). This is considered to be due to moisture absorption by MXene.

According to the research of the present inventors, it has been found that when an object is formed of a composite material (hereinafter, also simply referred to as “known composite material”) containing MXene and a resin material (refer to Non Patent Literature 1, such as polyurethane) conventionally used in the art, physical properties of the object formed of the known composite material change more greatly over time (typically, the conductivity is more greatly reduced over time) than those of the object formed of only MXene (MXene simple substance material). Such a tendency was more remarkably observed under a high humidity environment (for example, a relative humidity of 85%). That is, according to the research of the present inventors, it has been found that the above-described known composite material containing MXene and a resin material (polyurethane or the like) has a problem that environmental resistance (particularly moisture resistance) is lower than that of the MXene simple substance material.

The present disclosure is directed to provide a novel composite material containing MXene and a resin material, the composite material having improved environmental resistance (particularly moisture resistance) compared with known composite materials. Another object of the present disclosure is to provide a novel method for producing a composite material structure containing MXene and a resin material.
<1> A composite material, comprising:
particles of a two-dimensional material comprising one or plural layers; and
an anionic resin material comprising an anionic polymer having at least one of a carboxylic acid group and a carboxylic acid salt group and having no NH group, and excluding a resin material containing polyvinyl alcohol,
wherein the one or plural layers comprises a layer body represented by:

MₘXₙ
wherein M is at least one metal of Group 3, 4, 5, 6, or 7, X is a carbon atom, a nitrogen atom, or a combination thereof, n is not less than 1 and not more than 4, and m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom.
<2> The composite material according to <1>and constructed in a form of a structure body.
<3> The composite material according to <2>, wherein the structure body is a membrane.
<4> The composite material according to any one of <1>to <3>, wherein the resin material is an acrylic resin material.
<5> The composite material according to any one of <1>to <4>, wherein the resin material is a self-crosslinking resin material.
<6> The composite material according to any one of <1>to <5>, wherein a ratio of a solid content of the resin material to a total of the particles of the two-dimensional material and the solid content of the resin material in the composite material is not less than 0.1% by mass and not more than 99.9% by mass.
<7> The composite material according to any one of <1>to <6>, wherein the MₘXₙ is Ti₃C₂.
<8> A method for producing a composite material structure body, the method comprising:
(a) preparing a liquid composition containing particles of the two-dimensional material comprising one or plural layers, a resin material, and a liquid medium, the layers comprising a layer body represented by:

MₘXₙ
wherein M is at least one metal of Group 3, 4, 5, 6, or 7, X is a carbon atom, a nitrogen atom, or a combination thereof, n is not less than 1 and not more than 4, and m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom, and
wherein the resin material is an anionic resin material containing an anionic polymer having at least one of a carboxylic acid group and a carboxylic acid salt group and having no NH group, and excluding a resin material containing polyvinyl alcohol; and
(b) forming a precursor structure body on a substrate using the liquid composition, and at least drying the precursor structure body to obtain a composite material structure body.
<9> The method for producing a composite material structure body according to <8>, wherein the composite material structure body is a composite material membrane.
<10> The method for producing a composite material structure body according to <8> or <9>, wherein the resin material is an acrylic resin material.
<11> The method for producing a composite material structure body according to any one of <8> to <10>, wherein in the (a), the resin material is a self-crosslinking resin material.
<12> The method for producing a composite material structure body according to any one of <8> to <11>, wherein in the (a), a ratio of a solid content of the resin material to a total of the particles of the two-dimensional material and the solid content of the resin material in the liquid composition is not less than 0.1% by mass and not more than 99.9% by mass.
<13> The method for producing a composite material structure body according to any one of <8> to <12>, further comprising: before the (a),
etching a raw material represented by:

MₘXₙ
wherein A is at least one of Group 12, 13, 14, 15, and 16 elements, with an etching solution containing hydrofluoric acid to obtain the particles of the two-dimensional material.
<14> The method for producing a composite material structure body according to any one of <8> to <12>, further comprising: before the (a),
etching a raw material represented by:

MₘXₙ
wherein A is at least one of Group 12, 13, 14, 15, and 16 elements, with an etching solution containing fluoride and acid, and excluding hydrofluoric acid, to obtain particles of the two-dimensional material.
<15> The method for producing a composite material structure body according to any one of <8> to <14>, wherein the precursor structure body is formed by spraying the liquid composition onto the substrate in the (b).
<16> The method for producing a composite material structure body according to any one of <8> to <15>, wherein the MₘXₙ is Ti₃C₂.

According to the present disclosure, in a composite material containing particles of the predetermined two-dimensional material (also referred to as “MXene” in the present specification) and a resin material, an anionic resin material (excluding a resin material containing polyvinyl alcohol) containing an anionic polymer having at least one of a carboxylic acid group and a carboxylic acid salt group and having no NH group is used, and thereby a composite material having improved environmental resistance (particularly moisture resistance) as compared with known composite materials is provided. Further, according to the present disclosure, there is provided a novel method for producing a composite material structure group containing MXene and the resin material.

### BRIEF DESCRIPTION OF THE DRAWINGS

FIG. 1 is a schematic sectional view illustrating a composite material in one embodiment of the present disclosure.

FIGS. 2(a) and 2(b) are schematic sectional views illustrating two-dimensional material (MXene) particles which are usable in one embodiment of the present disclosure, in which FIG. 2(a) illustrates single-layered MXene particles, and FIG. 2(b) illustrates multi-layered (exemplarily two-layered) MXene particles.

FIG. 3 is a graph showing changes over time in conductivity of membranes produced in Example 1 and Comparative Examples 1 and 2.

FIG. 4 is a graph showing changes over time in conductivity of membranes produced in Example 2 and Comparative Examples 3 and 4.

FIG. 5 is a graph showing changes over time in conductivity of membranes produced in Example 3 and Comparative Examples 5 and 6.

### DETAILED DESCRIPTION OF THE PREFERRED EMBODIMENTS

Hereinafter, a composite material and a method for producing a composite material structure body (for example, a composite material having a form of a membrane) in an embodiment of the present disclosure will be described in detail, but the present disclosure is not limited to such an embodiment.

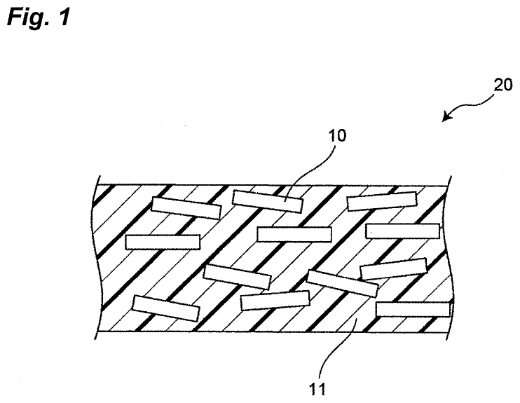

Referring to FIG. 1, a composite material 20 of the present embodiment contains particles 10 of a predetermined two-dimensional material (layered material) and an anionic resin material 11 (excluding a resin material containing polyvinyl alcohol) containing an anionic polymer having at least one of a carboxylic acid group and a carboxylic acid salt group and having no NH group (hereinafter, the anionic resin material having such a limitation is also simply referred to as “anionic resin material”). By using the anionic resin material 11 in combination with the particles 10 of a predetermined two-dimensional material (layered material), environmental resistance (particularly moisture resistance) can be improved as compared with a known composite material using polyurethane or the like.

The composite material 20 of the present embodiments may have any suitable structure and/or form. For example, the composite material 20 of the present embodiment may be a solid or non-flowable structure body (substantially free of liquid medium). The composite material structure body may be formed or molded into a predetermined shape. Examples of the composite material structure body include a composite material 20 having a form of a membrane, in other words, a composite material membrane (shown as the composite material 20 in FIG. 1). However, the composite material 20 of the present embodiment is not limited thereto, and may be, for example, a liquid composition (for example, slurry, paste, and the like) further containing a liquid medium (not shown in FIG. 1) described later.

Hereinafter, the composite material 20 of the present embodiment will be described in detail through a method for producing a composite material structure body (for example, a composite material membrane). Unless otherwise specified, the description in the method for producing the composite material structure body may also apply to the composite material.

A method for producing a composite material structure body of the present embodiment includes:
(a) preparing a liquid composition containing particles of a predetermined two-dimensional material (layered material), an anionic resin material, and a liquid medium; and
(b) forming a precursor structure body on a substrate using the liquid composition, and at least drying the precursor structure body to obtain a composite material structure body.

### Step (a)

### <MXene Particles >

First, particles of a predetermined two-dimensional material (layered material) are prepared. The predetermined two-dimensional material that can be used in the present embodiment is MXene, which is defined as follows:

A two-dimensional material (layered material) including one or plural layers, in which the layers includes a layer body represented by a formula below:

MₘXₙ
wherein M is at least one metal of Group 3, 4, 5, 6, or 7, and can contain at least one selected from the group consisting of so-called early transition metals, for example, Sc, Ti, Zr, Hf, V, Nb, Ta, Cr, Mo, and Mn, X is a carbon atom, a nitrogen atom, or a combination thereof, n is not less than 1 and not more than 4, and m is more than n but not more than 5(the layer body can have a crystal lattice in which each X is located in the octahedral array of M), and a modifier or terminal T existing on a surface of the layer body (more specifically, on at least one of both surfaces, facing each other, of the layered body), wherein T is at least one selected from the group consisting of a hydroxyl group, a fluorine atom, a chlorine atom, an oxygen atom, and a hydrogen atom (the material can be understood as a layered compound and also represented by “MₘXₙTₛ,” wherein s is any number and traditionally x may be used instead of s). Typically, n can be 1, 2, 3, or 4, but is not limited thereto.

In the above formula of MXene, M is preferably at least one selected from the group consisting of Ti, Zr, Hf, V, Nb, Ta, Cr, Mo, and Mn, and more preferably at least one selected from the group consisting of Ti, V, Cr, and Mo.

MXenes whose above formula MₘXₙ is expressed as below are known:
Sc₂C, Ti₂C, Ti₂N, Zr₂C, Zr₂N, Hf₂C, Hf₂N, V₂C, V₂N, Nb₂C, Ta₂C, Cr₂C, Cr₂N, Mo₂C, Mo_{1.3}C, Cr_{1.3}C, (Ti, V)₂C, (Ti,Nb)₂C, W₂C, W_{1.3}C, MO₂N, Nb_{1.3}C, MO_{1.3} Y_{0.6}C

(In the above formula, “1.3” and “0.6” mean about 1.3 (= 4/3) and about 0.6 (=⅔), respectively.),
Ti₃C₂, Ti₃N₂, Ti₃(CN), Zr₃C₂, (Ti, V)₃C₂, (Ti₂Nb)C₂, (Ti₂Ta)C₂, (Ti₂Mn)C₂, Hf₃C₂, (Hf₂V)C₂, (Hf₂Mn)C₂, (V₂Ti)C₂, (Cr₂Ti)C₂, (Cr₂V)C₂, (Cr₂Nb)C₂, (Cr₂Ta)C₂, (Mo₂Sc)C₂, (Mo₂ Ti)C₂, (Mo₂Zr)C₂, (Mo₂Hf)C₂, (Mo₂V)C₂, (MO₂Nb)C₂, (Mo₂Ta)C₂, (W₂Ti)C₂, (W₂Zr)C₂, (W₂Hf)C₂,
Ti₄N₃, V₄C₃, Nb₄C₃, Ta₄C₃, (Ti,Nb)₄C₃, (Nb,Zr)₄C₃, (Ti₂Nb₂)C₃, (Ti₂Ta₂)C₃, (V₂Ti₂)C₃, (V₂Nb₂)C₃, (V₂Ta₂)C₃, (Nb₂Ta₂)C₃, (Cr₂Ti₂)C₃, (Cr₂V₂)C₃, (Cr₂Nb₂)C₃, (Cr₂Ta₂)C₃, (MO₂Ti₂)C₃, (MO₂Zr₂)C₃, (MO₂Hf₂)C₃, (Mo₂V₂)C₃, (Mo₂Nb₂)C₃, (Mo₂Ta₂)C₃, (W₂Ti₂)C₃, (W₂Zr₂)C₃, (W₂Hf₂)C₃, (M_{02.7}V_{1.3})C₃ (In the above formula, “2.7” and “1.3” mean about 2.7 (= 8/3) and about 1.3 (= 4/3), respectively.),

Typically, the MₘXₙ is be represented by at least one selected from the group consisting of Ti₂C, Ti₃C₂, Ti₃(CN), (Cr₂Ti)C₂, (Mo₂Ti)C₂, (Mo₂Ti₂)C₃, and (Mo_{2.7}V_{1.3})C₃.

In particular, MₘXₙ may be Ti₃C₂.

Such MXene particles (hereinafter, the particles are simply referred to as “MXene particles”) can be synthesized by selectively etching (removing and optionally layer-separating) A atoms (and optionally a part of M atoms) from a MAX phase which is a raw material.

In other words, the method for producing the composite material structure of the present embodiment may further include a step of obtaining MXene particles before the step (a), and the step of obtaining MXene particles includes etching the MAX phase as a raw material with an etching solution (etching treatment).

The MAX phase which is a raw material (hereinafter, also simply referred to as “MAX raw material”) is represented by the formula below:

MₘAXₙ

wherein M, X, n, and m are as described above, A is at least one element of Group 12, 13, 14, 15, or 16, normally an element of Group A, typically of Group IIIA and Group IVA, more specifically can comprise at least one selected from the group consisting of Al, Ga, In, TI, Si, Ge, Sn, Pb, P, As, S, and Cd, and is preferably Al. The MAX phase has a crystal structure in which a layer constituted by A atoms is located between two layers represented by MₘXₙ (each X may have a crystal lattice located in an octahedral array of M). When typically m=n+1, but not limited thereto, the MAX phase includes repeating units in which each one layer of X atoms is disposed in between adjacent layers of n+1 layers of M atoms (these are also collectively referred to as an “MₘXₙ layer”), and a layer of A atoms (“A atom layer”) is disposed as a layer next to the (n+1) th layer of M atoms. The A atom layer (and optionally a part of the M atoms) is removed by selectively etching (removing and optionally layer-separating) the A atoms (and optionally a part of the M atoms) from the MAX phase. The surface of the exposed MₘXₙ layer is modified by hydroxyl groups, fluorine atoms, chlorine atoms, oxygen atoms, hydrogen atoms, etc., existing in an etching solution (usually, an aqueous solution containing hydrofluoric acid is used, but not limited thereto), so that the surface is terminated.

The etching solution may contain any suitable acid (HF, HCl, HBr, HI, sulfuric acid, phosphoric acid, nitric acid, and the like).

For example, the MAX raw material may be etched with an etching solution containing hydrofluoric acid. By using hydrofluoric acid for the etching solution, hydrofluoric acid (HF) is present in the etching solution. The etching treatment with an etching solution containing hydrofluoric acid may also be referred to as an ACID method. In addition to hydrofluoric acid, the etching solution may further contain other acids such as hydrochloric acid, hydrobromic acid, hydroiodic acid, nitric acid, sulfuric acid, acetic acid, formic acid, hypochlorous acid, and fluorosulfonic acid.

Alternatively, for example, the MAX raw material may be etched with an etching solution containing fluoride and acid (excluding hydrofluoric acid). By using fluoride and acid (excluding hydrofluoric acid) for the etching solution, hydrofluoric acid (HF) exists in situ in the etching solution. Etching by an etching solution containing fluoride and acid (excluding hydrofluoric acid) may also be referred to as an MILD method. As the fluoride, a metal fluoride, for example, lithium fluoride, sodium fluoride, potassium fluoride, or the like is used, and in particular, lithium fluoride can be used. When the metal fluoride is used, metal (metal ion) can be intercalated into the MXene particles together with the etching of the MAX raw material in the etching treatment. As the acid (excluding hydrofluoric acid), for example, hydrochloric acid, hydrobromic acid, hydroiodic acid, nitric acid, sulfuric acid, acetic acid, formic acid, hypochlorous acid, fluorosulfonic acid, and the like are used, and hydrochloric acid can be particularly used. Ammonium hydrogen difluoride may be used as the fluoride and the acid (excluding hydrofluoric acid).

In the present embodiment, the etching treatment (ACID method) with an etching solution containing hydrofluoric acid is more preferable than the etching treatment (MILD method) with an etching solution containing fluoride and acid (excluding hydrofluoric acid) (refer to Examples described later).

The step of obtaining the MXene particles may appropriately include any appropriate treatment after the etching treatment. Examples of such treatment include washing, intercalation, delamination, and the like. The washing may apply a water wash followed by centrifugation/decantation. The intercalation may intercalate a metal (metal ion) into the MXene particles. The delamination may promote delamination (the multilayer MXene particles are made into MXene particles having a smaller number of layers, for example, single-layer MXene particles) of the MXene particles by applying an impact such as vibration and/or ultrasonic waves. For example, the delamination treatment can be performed for a predetermined time by a handshake, an automatic shaker, a mechanical shaker, a vortex mixer, a homogenizer, an ultrasonic bath, or the like.

It is noted, in the present disclosure, MXene particles may contain remaining A atoms at a relatively small amount, for example, at 10% by mass or less with respect to the original amount of A atoms. The remaining amount of A atoms can be preferably 8% by mass or less, and more preferably 6% by mass or less. However, even if the residual amount of A atoms exceeds 10% by mass, there may be no problem depending on the application and use conditions of the composite material.

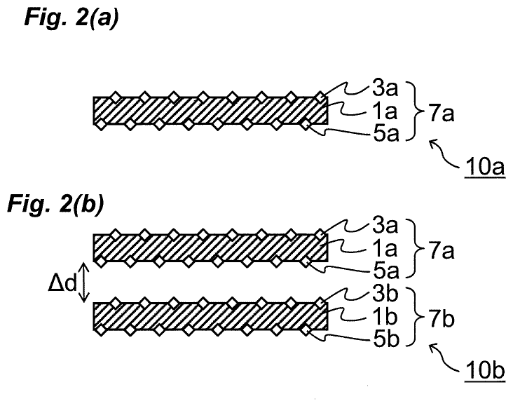

As schematically illustrated in FIG. 2, the MXene particles 10 synthesized in this manner may be particles of the layered material (as examples of the MXene particles 10, the MXene particles 10a in one layer are illustrated in FIG. 2(a), and the MXene particles 10b in two layers are illustrated in FIG. 2(b), but the present disclosure is not limited to these examples) including one or plural MXene layers 7a and 7b. More specifically, the MXene layers 7a, 7b have layer bodies (MₘX) layers) 1a, 1b represented by MₘXₙ, and modifiers or terminals T 3a, 5a, 3b, 5b existing on the surfaces of the layer bodies 1a, 1b (more specifically, on at least one of both surfaces, facing each other, of each layer). Therefore, the MXene layers 7a, 7b are also represented by “MₘXₙTₛ,” wherein s is any number. The MXene particles 10 may be one in which such MXene layers are individually separated and exist in one layer (the single-layer structure illustrated in FIG. 2(a), so-called single-layer MXene particles 10a), a laminate in which plural MXene layers are stacked apart from each other (the multilayer structure illustrated in FIG. 2(b), so-called multilayer MXene particles 10b), or a mixture thereof. The MXene particles 10 may be particles (which may also be referred to as powders or flakes) as an aggregate formed of the single-layer MXene particles 10a and/or the multilayer MXene particles 10b. In the case of multilayer MXene particles, two adjacent MXene layers (for example, 7a and 7b) do not necessarily have to be completely separated from each other, and may be partially in contact with each other.

Although the present embodiment is not limited, the thickness of each layer of MXene (which corresponds to the MXene layers 7a and 7b) is, for example, not less than 0.8 nm and not more than 5 nm, and particularly not less than 0.8 nm and not more than 3 nm (which may mainly vary depending on the number of M atom layers included in each layer), and the maximum dimension (which may correspond to the “in-plane dimension” of the particle) in a plane parallel to the layer (two-dimensional sheet plane) is, for example, 0.1 μm or more, particularly 1 μm or more, for example, 200 μm or less, and particularly 40 μm or less.

When the MXene particles are laminate (multilayer MXene) particles, an interlayer distance (alternatively, a void dimension, indicated by Δd in FIG. 2(b)) inside each of the laminate particles is not particularly limited, and is, for example, not less than 0.8 nm and less than 10 nm, particularly not less than 0.8 nm and not more than 5 nm, and more particularly about 1 nm, and the maximum dimension (which may correspond to the “in-plane dimension” of the particles) in a plane (two-dimensional sheet plane) perpendicular to the lamination direction is, for example, 0.1 μm or more, particularly 1 μm or more, for example, 100 μm or less, and particularly 20 μm or less.

The total number of layers in the MXene particles may be 1 or not less than 2, but is, for example, not less than 1 and not more than 20, and the thickness in the lamination direction (which may correspond to the “thickness” of the particles) is, for example, not less than 0.8 nm and not more than 20 nm.

When the MXene particles are laminate (multilayer MXene) particles, the MXene particles may have a small number of layers. The term “small number of layers” means, for example, that the number of stacked layers of MXene is 6 or less. In addition, the thickness of the multilayer MXene having a small number of layers in the lamination direction may be less than 10 nm. In the present specification, the “multilayer MXene having a small number of layers” is also referred to as a “few-layer MXene”.

Although the present embodiment is not limited, the MXene particles may be particles (also referred to as nanosheets) in which most of the MXene particles are formed of single-layer MXene and/or few-layer MXene. In the present specification, the single-layer MXene and the small number of layers MXene may be collectively referred to as “single-layer/few-layer MXene”.

It should be noted that these dimensions described above may be determined as number average dimensions (for example, number average of at least 40) based on photographs of a scanning electron microscope (SEM), a transmission electron microscope (TEM), or an atomic force microscope (AFM), or as distances in the real space calculated from the positions on the reciprocal lattice space of the (002) plane measured by an X-ray diffraction (XRD) method.

### <Anionic Resin Material >

Separately, an anionic resin material is prepared. In the present disclosure, the “anionic resin material” is an anionic resin material (excluding a resin material containing polyvinyl alcohol) containing an anionic polymer having at least one of a carboxylic acid group and a carboxylic acid salt group and having no NH group.

The anionic polymer is a polymer (high molecular weight polymer) having an anionic functional group and showing a negative charge (showing a negative zeta potential) in a liquid medium. The proportion of the monomer unit having an anionic functional group in the anionic polymer is not particularly limited as long as the anionic polymer exhibits a negative charge (exhibits a negative zeta potential) in a liquid medium. The anionic resin material may contain an anionic polymer. The anionic resin material may contain any suitable other component in addition to the anionic polymer. The anionic resin material may contain one or two or more anionic polymers, but preferably does not contain a polymer having a high molecular weight other than the anionic polymer.

The fact that the anionic polymer has at least one of a carboxylic acid group and a carboxylic acid salt group means that the anionic polymer has —COOH and/or —COOX′ (X′ is, for example, a monovalent ion such as sodium, potassium, or ammonium). The carboxylic acid group and the carboxylic acid salt group are anionic functional groups that form —COO— in a liquid medium. The anionic polymer may or may not further contain at least one or more other anionic functional groups such as a sulfonic acid group, a sulfonic acid group, a phosphoric acid group, and a phosphoric acid group.

In the present disclosure, the anionic polymer is required not to have an NH group. The NH group may be —N(H)— present in the main chain and/or side chain of the polymer, and the H of the NH group may form a hydrogen bond. Therefore, the anionic polymer does not have, for example, a urethane bond (—NHCOO—).

However, the anionic resin material that can be used in the present disclosure excludes a resin material containing polyvinyl alcohol (PVA) (hereinafter, also simply referred to as “PVA-containing resin material”). The PVA-containing resin material excluded in the present disclosure is a resin material containing PVA in addition to the anionic polymer. PVA (polyvinyl alcohol) means a polymer (polymer) containing a monomer unit derived from vinyl alcohol as a main component. The PVA may be, for example, a homopolymer of vinyl alcohol, a copolymer of vinyl alcohol and vinyl acetate, or the like. PVA can be understood as a nonionic polymer with a hydroxyl group as a nonionic functional group. In other words, the PVA-containing resin material excluded in the present disclosure can be understood as an anionic-nonionic hybrid resin material because it contains an anionic polymer and PVA that is a nonionic polymer. As examples of the nonionic functional group, a hydroxyl group, an alkylene oxide group, and the like are known.

In the present embodiment, the anionic resin material may be an acrylic resin material. In other words, the anionic resin material may contain an anionic acrylic polymer as the anionic polymer. Such an anionic acrylic polymer has at least one of a carboxylic acid group and a carboxylic acid salt group, and does not have an NH group. The acrylic polymer means a polymer (polymer) containing a monomer unit derived from a (meth) acryloyl group as a main component. “(Meth) acryloyl group” means an acryloyl group and/or a methacryloyl group. The main component means a component that accounts for 50% by mass or more of the polymer.

In the present embodiment, the anionic resin material is preferably a self-crosslinking resin material. The self-crosslinking anionic resin material may have a self-crosslinking functional group introduced into an anionic polymer (for example, an anionic acrylic polymer), and may be crosslinkable by the anionic polymer alone, or may have a reactive functional group introduced into an anionic polymer, and may be crosslinkable by reacting with a crosslinking agent, or may be both of them.

For example, the crosslinking may be performed by a crosslinking reaction between a polymer into which a reactive functional group such as a carboxylic acid group, a sulfonic acid group, a carbonyl group, or a hydroxyl group is introduced and a crosslinking agent having a crosslinkable functional group. The crosslinking can also be performed by copolymerization of a crosslinkable monomer having two or more vinyl groups in one molecule (for example, ethylene glycol di (meth)acrylate, polyethylene glycol di (meth)acrylate, divinylbenzene, and the like) or introduction of a monomer having a self-crosslinkable functional group (for example, a methylol group-containing monomer, a hydrolyzable silyl group-containing monomer, or the like).

Other components that may be included in the anionic resin material may be additives. Examples of the additive include, but are not limited to, a surfactant, a curing agent and/or a crosslinking agent, a viscosity modifier (for example, a thickener), and the like. Examples of the surfactant include tetraethylene glycol.

Examples of the commercially available anionic resin material include ARON (registered trademark) NW-400 (contains an anionic acrylic polymer which has at least one of a self-crosslinking type carboxylic acid group and a carboxylic acid salt group and does not have an NH group, contains tetraethylene glycol as a surfactant, and does not contain PVA, manufactured by Toagosei Co., Ltd.) and Lipidure (registered trademark)-A (manufactured by NOF CORPORATION). The commercially available anionic resin material as a raw material may further contain a liquid medium as appropriate. In the present disclosure, examples of the PVA-containing resin material excluded from the anionic resin material include ARON (registered trademark) AS-2000 (contains a non-reactive, anionic acrylic (acrylic acid-based) polymer manufactured by Toagosei Co., Ltd., and PVA).

### <Liquid Composition >

A liquid composition containing the MXene particles and the anionic resin material respectively prepared above in a liquid medium is prepared.

The liquid medium may be either an aqueous medium or an organic medium, and an aqueous medium is preferable. The aqueous medium is typically water, and in some cases, other liquid substances may be contained in a relatively small amount (for example, 30% by mass or less, preferably 20% by mass or less based on the whole mass of aqueous medium) in addition to water. The organic medium is not particularly limited, and may be, for example, a protic solvent represented by an alcohol, an aprotic solvent, or the like, or may be a mixed solvent of two or more thereof.

In the obtained liquid composition, the MXene particles can be well dispersed in a liquid medium by the anionic resin material. As described later, by using a liquid composition having good dispersibility of MXene particles, environmental resistance (particularly moisture resistance) of a finally obtained composite material (a composite material structure body in this production example, but not limited thereto) can be improved (as compared with known composite materials).

The ratio of the solid content of the anionic resin material to the total of the MXene particles and the solid content of the anionic resin material in the liquid composition may be not less than 0.1% and not more than 99.9% by mass, and the effect of improving environmental resistance (particularly moisture resistance) can be exhibited in such a range. The ratio in the liquid composition may be substantially the same as the ratio of the solid content of the anionic resin material to the total of the solid content of the MXene particles and the solid content of the anionic resin material in the finally obtained composite material (a composite material structure body in this production example, but not limited thereto).

The liquid composition may be in the form of a slurry, a paste, or the like depending on the total solid content concentration containing the MXene particles and the solid content of the anionic resin material.

### Step (b)

### <Precursor Structure Body>

Then, a precursor structure body is formed on a substrate using the liquid composition prepared above, and at least the precursor structure body is dried to obtain a composite material structure body. When the composite material structure body is a composite membrane, the precursor structure body is a precursor membrane.

The substrate is not particularly limited, and may be formed of any suitable material and have any suitable structure and/or form. In the surface of the substrate, a region where the precursor structure body is formed may or may not be flat, and may have a surface shape such as a curved surface shape, an uneven shape, or an irregular shape. The substrate may be typically, but not limited to, a substrate, a film, or the like.

In order to obtain higher adhesion between the finally formed composite material membrane and the substrate, the substrate surface (the surface on which the precursor structure body is formed) preferably has a functional group (for example, an OH group or the like) capable of hydrogen bonding with the MXene particles. Such a functional group may be originally possessed by the substrate, or may be developed by performing pretreatment (for example, plasma treatment). The pretreatment may be performed for the purpose of washing, hydrophilization, or the like.

The method for forming the precursor structure body on the substrate is not particularly limited, but for example, the precursor structure body may be formed by spraying a liquid composition on the substrate. However, the precursor structure body may be formed on the porous member by a method other than spraying, for example, by using a porous member (for example, a membrane filter) as a substrate and passing (filtering) the liquid composition to the porous member. The spray can orient and arrange the MXene particles on the substrate (the MXene particles are aligned so that the two-dimensional sheet surfaces of the MXene particles are substantially parallel to the surface of the substrate (for example, within)) ±20°, and the final resulting composite material structure body is made denser than the filtration membrane, thereby obtaining higher environmental resistance (moisture resistance). In addition, any method such as bar coating, spin coating, or immersion can be applied.

Drying the precursor structure removes unnecessary liquid media (the entire liquid medium is not necessarily removed, and a part of the liquid medium may remain) to form a composite material structure. The spraying and drying may be repeated to obtain a composite material structure of a desired thickness.

When the self-crosslinking anionic resin material is used, the crosslinking reaction may proceed while the composite material structure body is formed. For example, the crosslinking reaction may proceed by at least partially removing the liquid medium by drying. For example, the crosslinking reaction may proceed by performing heating, radiation (light, ultraviolet light, or the like) irradiation, or the like under appropriate conditions in addition to drying according to the self-crosslinking anionic resin material to be used.

### <Composite Material Structure>

Since the composite material structure body obtained as described above is produced using a liquid composition having good dispersibility of MXene particles, environmental resistance (particularly moisture resistance) can be improved (as compared with a membrane formed of a known composite material).

Although the present disclosure is not bound by any theory, the reason why the environmental resistance (particularly moisture resistance) can be improved (as compared with known composite materials) by using a liquid composition (a composite material structure body in this production example, but not limited thereto) having good dispersibility of MXene particles is considered as follows.

The MXene particles have modifiers or terminals T (T is at least one selected from the group consisting of a hydroxyl group, a fluorine atom, a chlorine atom, an oxygen atom, and a hydrogen atom) on the surface of the layer body represented by MₘXₙ, and a charged site in such a configuration exists. The two-dimensional sheet surface (plane parallel to the layer of MXene particles) that occupies most of the surface of the MXene particles is usually negatively charged. When the MXene particles are mixed with a liquid medium (typically, water), the MXene particles may be attracted to each other by intermolecular force or hydrogen bonding force in the liquid medium to aggregate. In the present embodiment, in addition to the MXene particles and the liquid medium, an anionic resin material containing an anionic polymer having at least one of a carboxylic acid group and a carboxylic acid salt group and having no NH group is used. The carboxylic acid group and/or the carboxylic acid salt group of the anionic polymer may yield —C(═O)O⁻ in a liquid medium. In addition, ═O in the carboxylic acid group and/or carboxylic acid salt group of the anionic polymer may function as a hydrogen acceptor, and H in the carboxylic acid group of the anionic polymer may function as a hydrogen donor of a hydrogen bond, and may form a (relatively loose) hydrogen bond with the MXene particles. In the modifier or terminal T of the MXene particles, a fluorine atom, a chlorine atom, and an oxygen atom may function as a hydrogen acceptor, and a hydroxyl group and a hydrogen atom may function as a hydrogen donor. Therefore, in the liquid medium, while the negative charges on the surface of the MXene particles and —C(—O)O— of the anionic polymer strongly electrostatically repel each other, a loose hydrogen bond can be formed between the MXene particles and the anionic polymer (note that plural monomer units having a carboxylic acid group and/or a carboxylic acid salt group are present in the anionic polymer). Such electrostatic repulsion and hydrogen bonding are suitably balanced, and as a result, aggregation of MXene particles can be effectively prevented by steric repulsion of the anionic polymer, and the MXene particles can be well dispersed. The MXene particles are extremely sensitive to the functional group of the polymer, and among the anionic functional groups, the MXene particles can be well dispersed by using an anionic polymer having a carboxylic acid group and/or a carboxylic acid salt group capable of forming a loose hydrogen bond and being anionic and capable of electrostatic repulsion.

Such good dispersibility of the MXene particles can be secured by the fact that the anionic polymer does not have an NH group. The NH group may function as a cationic functional group. In addition, the NH group may function as a hydrogen donor, and the MXene particle may form a strong hydrogen bond with the NH group. If the anionic polymer has an NH group, an electrostatic attractive force acts between a negative charge on the surface of the MXene particles and the NH group of the anionic polymer in a liquid medium, or a hydrogen bond acts too strongly between the MXene particles and the NH group of the anionic polymer, so that the MXene particles are connected to each other via the anionic polymer, whereby aggregation of the MXene particles may occur. In the present embodiment, since the anionic polymer does not have an NH group, such a problem can be avoided.

In addition, anionic resin materials usable in the present disclosure exclude PVA-containing resin materials. The present inventors have confirmed that PVA has an extremely strong action of aggregating MXene particles. Even when the PVA-containing resin material contains an anionic polymer, the aggregation action by PVA is stronger than the effect of electrostatic repulsion between the negative charge on the surface of the MXene particles and —C(═O)O— of the anionic polymer in a liquid medium. As a result, aggregation of the MXene particles cannot be effectively prevented, and the MXene particles may not be well dispersed.

By using the liquid composition having good dispersibility of the MXene particles as described above, the MXene particles can be densely present in the finally obtained composite material (in this production example, a composite material structure body is used, the same applies below). In the liquid composition having good dispersibility of the MXene particles, it is considered that the MXene particles are uniformly dispersed in the liquid medium. Also in the precursor structure body formed using such a liquid composition, it is considered that the MXene particles are uniformly dispersed in the liquid medium, and in the composite material after drying, the MXene particles can be present in a highly oriented state. When the composite material structure is formed on the substrate as in the present production example, the MXene particles can be arranged in an aligned manner such that two-dimensional sheet surfaces of the MXene particles are substantially parallel (for example, within ±20°) to the surface of the substrate. As a result, a composite material having a high density of MXene particles is obtained. A composite material having a high density of the MXene particles is less susceptible to an ambient environment, and thus can improve environmental resistance (compared to a known composite material). For example, under high humidity conditions, a composite material having a higher density of the MXene particles is less likely to allow water molecules to enter (has a smaller entry route for water molecules), and thus can improve moisture resistance.

On the other hand, unlike the present embodiment, in the liquid composition in which the dispersibility of the MXene particles is poor, it is considered that the MXene particles are unevenly distributed in the liquid medium and partially aggregated. Even in the precursor structure body formed using such a liquid composition, it is considered that the MXene particles are unevenly distributed in the liquid medium and partially aggregated and exist, and the aggregated MXene particles interfere with the orientation of the MXene particles during drying (during membrane formation), and the orientation of the MXene particles is disturbed. As a result, voids are generated in the vicinity of the aggregated MXene particles, and a composite material having a low density of the MXene particles is formed. The composite materials with a low density of the MXene particles are susceptible to the ambient environment, thus resulting in reduced environmental resistance (as in known composite materials). For example, under high humidity conditions, a composite material having a lower density of the MXene particles is likely to be infiltrated by water molecules (has more infiltration paths of water molecules), and thus has poor moisture resistance.

As understood from the above, in the present embodiment, by using a liquid composition having good dispersibility of the MXene particles, a composite material having a high density of the MXene particles (a composite material structure body in this production example) is obtained, and thus environmental resistance (particularly moisture resistance) can be improved as compared with known composite materials, and preferably, environmental resistance (particularly moisture resistance) equivalent to that of the MXene simple substance material (substantially formed only of the MXene particles, and does not contain a resin material) can be realized.

Furthermore, although not essential to the present embodiment, the anionic resin material is preferably a self-crosslinking resin material. Accordingly, environmental resistance (particularly moisture resistance) can be further improved. The present disclosure is not bound by any theory, and the reason is considered as follows.

The self-crosslinking resin material may be one in which a self-crosslinking functional group and/or a reactive functional group (capable of reacting with a crosslinking agent) is introduced into an anionic polymer. The MXene particles may have a hydroxyl group or the like as the modifier or terminal T, and such modifier or terminal T may cause a crosslinking reaction with the self-crosslinking and/or reactive functional group of the anionic polymer. When the anionic polymer crosslinked with the MXene particles is further crosslinked with another MXene particle, the anionic polymer is crosslinked between the plural MXene particles. The MXene particles crosslinked in this manner are chemically bonded to each other, and are hardly affected by the surrounding environment, and thus environmental resistance can be further improved. For example, under a high humidity condition, the MXene particles are less likely to be opened by water molecules, and thus the moisture resistance can be further improved.

The environmental resistance can be determined based on the temporal change rate of the physical properties of the composite material under a predetermined environment, and the environmental resistance (particularly moisture resistance) is higher as the change rate is smaller. More specifically, the moisture resistance can be determined based on the temporal change rate of the physical properties of the composite material under a high humidity environment (for example, a relative humidity of 85%), particularly under a high temperature and high humidity environment (for example, a temperature of 60° C. and a relative humidity of 85%), and the smaller the change rate, the higher the moisture resistance. The physical properties of the composite material may be electrical properties, typically conductivity. In other words, according to the present embodiment, it is possible to improve the temporal decreasing rate of the conductivity of the finally obtained composite material (the composite material structure body in this production example) (as compared with the known composite material).

The ratio of the solid content of the anionic resin material to the total of the solid content of the MXene particles and the solid content of the anionic resin material in the finally obtained composite material (a composite material structure body in this production example) may be not less than 0.1% by mass and not more than 99.9% by mass, similarly to the ratio in the liquid composition. When a conductive composite material is required, the ratio of the MXene particles to the total of the MXene particles and the solid content of the anionic resin material may be, for example, not less than 50% by mass and not more than 99.9% by mass although it depends on the anionic resin material to be used.

In addition, according to the present embodiment, it is possible to obtain high adhesion between the composite material structure body and the substrate as compared with the case of the membrane made of the MXene simple substance material. The membrane made of the MXene simple substance material is easily cohesively peeled off by tape peeling (conforming to the cross-cut method defined in JIS K5600-5-6). On the other hand, in the present embodiment, since the composite material containing the MXene particles and the anionic resin material is used, it is possible to prevent cohesive peeling and to secure membrane strength and adhesion.

The composite material (structure body, for example, a membrane) of the present embodiments may be utilized in any suitable application. For example, it may be used in applications where maintaining high conductivity (to reduce a decrease in initial conductivity) is required, such as electrodes or electromagnetic shielding (EMI shielding) in any suitable electric device.

The electrode is not particularly limited, and may be, for example, a capacitor electrode, a battery electrode, a bioelectrode, a sensor electrode, an antenna electrode, an electrolysis electrode, or the like. By using the composite material (structure body, for example, a membrane) of the present embodiment, it is possible to obtain a large-capacity capacitor and battery, a low-impedance bioelectrode, a highly sensitive sensor, and an antenna even with a smaller volume (device occupied volume).

The capacitor may be an electrochemical capacitor. The electrochemical capacitor is a capacitor using capacitance developed due to a physicochemical reaction between an electrode (electrode active material) and ions (electrolyte ions) in an electrolytic solution, and can be used as a device (power storage device) that stores electric energy. The battery may be a repeatedly chargeable and dischargeable chemical battery. The battery may be, for example, but not limited to, a lithium ion battery, a magnesium ion battery, a lithium sulfur battery, a sodium ion battery, or the like.

The bioelectrode is an electrode for acquiring a biological signal. The bioelectrode may be, for example, but not limited to, an electrode for measuring electroencephalogram (EEG), electrocardiogram (ECG), electromyogram (EMG), electrical impedance tomography (EIT).

The sensor electrode is an electrode for detecting a target substance, state, abnormality, or the like. The sensor may be, for example, but not limited to, a gas sensor, a biosensor (a chemical sensor utilizing a molecular recognition mechanism of biological origin), or the like.

The antenna electrode is an electrode for emitting an electromagnetic wave into a space and/or receiving an electromagnetic wave in the space.

Particularly, by using the composite material (structure body, for example, a membrane) of the present embodiment, an electromagnetic shield having a high shielding rate (EMI shielding property) can be obtained.

Although the composite material and the method for producing the composite material structure body in one embodiment of the present disclosure have been described in detail above, the present disclosure can be modified in various ways. It should be noted that the composite material of the present disclosure may be produced by a method different from the producing method in the above-described embodiment.

### EXAMPLES

### Example 1

### Production of MAX Particles (Precursor of MXene Particles)

TiC powder, Ti powder, and Al powder (all manufactured by Kojundo Chemical Laboratory Co., Ltd.) were placed in a ball mill containing zirconia balls at a molar ratio of 2:1:1 and mixed for 24 hours. The obtained mixed powder was calcined in an Ar atmosphere at 1350° C. for 2 hours. The fired body (block) thus obtained was crushed with an end mill to a maximum size of 40 μm or less. In this way, Ti₃AlC₂ particles were obtained as MAX particles.
Etching of Precursor (ACID Method)

Using the Ti₃AlC₂ particles (powder) produced by the above method, etching was performed under the following etching conditions to obtain a solid-liquid mixture (slurry) containing a solid component derived from the Ti₃AlC₂ powder.

### Etching Conditions

Precursor: Ti₃AlC₂ (sieving with a mesh size of 45 μm)
Etching solution composition: 6 mL of 49% HF,

H₂O 18 mL

HCl (12M) 36 mL
Amount of precursor input: 3.0 g
Etching container: 100 ml bottle made of polypropylene (Aiboy)
Etching temperature: 35° C.
Etching time: 24 h.
Stirrer rotation speed: 400 rpm
Washing after etching

The slurry was divided into two portions, each of which was inserted into two 50 mL centrifuge tubes, centrifuged under the condition of 3500 G using a centrifuge, and then the supernatant was discarded. An operation of adding 40 mL of pure water to the remaining precipitate in each centrifuge tube, centrifuging again at 3500 G, and separating and removing the supernatant was repeated 11 times. After final centrifugation, the supernatant was discarded to obtain a Ti₃C₂Tₓ-moisture medium clay.

### Li Intercalation

The Ti₃C₂ Tₓ-moisture medium clay produced by the above method was stirred at 20° C. or higher and 25° C. or lower for 12 hours using LiCl as a Li-containing compound according to the following conditions to perform intercalation of Li.

### Conditions of intercalation of Li

Ti₃C₂ Tₓ-moisture medium clay (MXene after washing): Solid content 0.75 g
LiCl: 0.75 g
Intercalation container: 100 ml bottle made of polypropylene (Aiboy)
Temperature: not lower than 20° C. and not higher than 25° C. (room temperature)
Time: 10 h
Stirrer rotation speed: 800 rpm
Delamination

Next, (i) 40 mL of pure water was added to the Ti₃C₂Tₓ-moisture medium clay, and the mixture was stirred for 15 minutes with a shaker, then (ii) centrifuged at 3500 G, and (iii) the supernatant was recovered as a single-layer MXene-containing liquid. The operations (i) to (iii) were repeated 4 times in total to obtain a single-layer MXene-containing supernatant. Further, this supernatant was centrifuged under the conditions of 4300 G and 2 hours using a centrifuge, and then the supernatant was discarded to obtain a single-layer/few-layer MXene-containing clay as a single-layer/few-layer MXene-containing sample.

### Preparation of MXene-Aqueous Dispersion

The MXene-containing clay and pure water were mixed in appropriate amounts to prepare MXene-aqueous dispersion (MXene slurry) having a solid content concentration (MXene particle concentration) of 34 mg/mL.

### Formation of Membrane (Composite Material Membrane)

In a 50 mL centrifuge tube, 0.069 g of an anionic acrylic resin material (ARON (registered trademark) NW-400, manufactured by Toagosei Co., Ltd.) as a resin material was put, and then 22.284 g of pure water was added to dilute the resin material. 17.647 g of the MXene-aqueous dispersion (MXene particles: solid concentration 34 mg/mL) prepared as described above was added to the diluted resin material to make a total amount of 40.00 g.

Thereafter, the mixture was shaken and stirred for 15 minutes using an automatic shaker (SK550 1.1, manufactured by FAST & Fluid, Inc.) to prepare a liquid composition containing MXene particles and a resin material. In this liquid composition, aggregation of MXene particles was not observed.

The obtained liquid composition was sprayed onto a 3 cm square glass substrate (Tempax, manufactured by SCHOTT) whose surface had been cleaned with oxygen plasma in advance using a spray coater to form a precursor membrane including the liquid composition. After spraying, it was dried with hot air. The above spraying and drying were repeated 20 times in total. Thereafter, the precursor membrane was dried in a normal pressure oven at 80° C. for 2 hours and further in a vacuum oven at 150° C. for about 15 hours to obtain a composite material membrane (spray method).

The mass ratio between the MXene particles and the solid content of the resin material in the composite material membrane may be considered to be 95% by mass: 5% by mass from the composition of the liquid composition used.

### Comparative Example 1

### Formation of Membrane (MXene Simple Substance Material Membrane)

A MXene-aqueous dispersion (MXene particles: solid concentration 34 mg/mL) was prepared in the same manner as in Example 1.

22.353 g of pure water was added to a 50 mL centrifuge tube, and 17.647 g of the MXene-aqueous dispersion (MXene particles: solid concentration 34 mg/mL) prepared as described above was added thereto so as to make a total amount of 40.00 g. Thereafter, the mixture was shaken and stirred for 15 minutes using an automatic shaker (SK550 1.1,manufactured by FAST&Fluid, Inc.) to prepare a liquid composition containing MXene particles and not containing a resin material.

A MXene simple substance material membrane was obtained in the same manner as in Example 1 except that the obtained liquid composition was used.

### Comparative Example 2

### Formation of Membrane (Composite Material Membrane)

A MXene-aqueous dispersion (MXene particles: solid concentration 34 mg/mL) was prepared in the same manner as in Example 1.

In a 50 mL centrifuge tube, 0.108 g of an anionic polyurethane-based resin material (RESAMINE D-4090, manufactured by Dainichiseika Color & Chemicals Mfg. Co., Ltd.) as a resin material was put, and then 22.245 g of pure water was added to dilute the resin material. 17.647 g of the MXene-aqueous dispersion (MXene particles: solid concentration 34 mg/mL) prepared as described above was added to the diluted resin material to make a total amount of 40.00 g. Thereafter, the mixture was shaken and stirred for 15 minutes using an automatic shaker (SK550 1.1, manufactured by FAST & Fluid, Inc.) to prepare a liquid composition containing MXene particles and a resin material.

A composite material membrane was obtained in the same manner as in Example 1 except that the obtained liquid composition was used. In the liquid composition obtained as described above, the MXene particles were slightly aggregated, but a membrane could be formed.

The mass ratio between the MXene particles and the solid content of the resin material in the composite material membrane may be considered to be 95% by mass: 5% by mass from the composition of the liquid composition used.

### Example 2

### Production of MAX Particles (Precursor of MXene Particles)

MAX particles were obtained in the same manner as in Example 1.
Etching (MILD method) of precursor and intercalation of Li

Using the Ti₃AlC₂ particles (powder) prepared by the above method, etching and intercalation of Li were performed together under the following etching conditions to obtain a solid-liquid mixture (slurry) containing a solid component derived from the Ti3AlC2 powder.

### Conditions of etching of precursor and intercalation of Li

Precursor: Ti₃AlC₂ (sieving with a mesh size of 45 μm)
Etching solution composition: LiF 3 g

HCl (9M) 30mL
Amount of precursor input: 3 g
Etching container: 100 mL bottle made of polypropylene (Aiboy)
Etching temperature: 35° C.
Etching time: 24 h
Stirrer rotation speed: 400 rpm
Washing after etching

The slurry was divided into two portions, each of which was inserted into two 50 mL centrifuge tubes, centrifuged under the condition of 3500 G using a centrifuge, and then the supernatant was discarded. (i) 40 mL of pure water was added to the remaining precipitate in each centrifuge tube and (ii) centrifuged again at 3500 G to (iii) separate and remove the supernatant. The operations (i) to (iii) were repeated 10 times in total, it was confirmed that the pH of the 10th supernatant was more than 5, and the supernatant was discarded to obtain a Ti₃C₂Tₓ-moisture medium clay.

### Delamination

Next, (i) 40 mL of pure water was added to the Ti₃C₂Tₓ-moisture medium clay, and the mixture was stirred for 15 minutes with a shaker, then (ii) centrifuged at 3500 G, and (iii) the supernatant was recovered as a single-layer MXene-containing liquid. The operations (i) to (iii) were repeated 4 times in total to obtain a single-layer MXene-containing supernatant. Further, this supernatant was centrifuged under the conditions of 4300 G and 2 hours using a centrifuge, and then the supernatant was discarded to obtain a single-layer/few-layer MXene-containing clay as a single-layer/few-layer MXene-containing sample.

### Preparation of MXene-Aqueous Dispersion

The MXene-containing clay and pure water were mixed in appropriate amounts to prepare MXene-aqueous dispersion (MXene slurry) having a solid content concentration (MXene particle concentration) of 84 mg/mL.

### Formation of Membrane (Composite Material Membrane)

In a 50 mL centrifuge tube, 0.069 g of an anionic acrylic resin material (ARON (registered trademark) NW-400, manufactured by Toagosei Co., Ltd.) as a resin material was put, and then 32.165 g of pure water was added to dilute the resin material. 7.143 g of the MXene-aqueous dispersion (MXene particles: solid concentration 84 mg/mL) prepared as described above was added to the diluted resin material to make a total amount of 40.00 g. Thereafter, the mixture was shaken and stirred for 15 minutes using an automatic shaker (SK550 1.1, manufactured by FAST&Fluid, Inc.) to prepare a liquid composition containing MXene particles and a resin material.

A composite material membrane was obtained in the same manner as in Example 1 except that the obtained liquid composition was used.

The mass ratio between the MXene particles and the solid content of the resin material in the composite material membrane may be considered to be 95% by mass: 5% by mass from the composition of the liquid composition used.

### Comparative Example 3

### Formation of Membrane (MXene Simple Substance Material Membrane)

A MXene-aqueous dispersion (MXene particles: solid concentration 84 mg/mL) was prepared in the same manner as in Example 2.

31.76 g of pure water was added to a 50 mL centrifuge tube, and 7.14 g of the MXene-aqueous dispersion (MXene particles: solid concentration 84 mg/mL) prepared as described above was added thereto so as to make a total amount of 40.00 g. Thereafter, the mixture was shaken and stirred for 15 minutes using an automatic shaker (SK550 1.1,manufactured by FAST&Fluid, Inc.) to prepare a liquid composition containing MXene particles and not containing a resin material.

A MXene simple substance material membrane was obtained in the same manner as in Example 1 except that the obtained liquid composition was used.

### Comparative Example 4

### Formation of Membrane (Composite Material Membrane)

A MXene-aqueous dispersion (MXene particles: solid concentration 84 mg/mL) was prepared in the same manner as in Example 2.

In a 50 mL centrifuge tube, 0.108 g of an anionic polyurethane-based resin material (RESAMINE D-4090, manufactured by Dainichiseika Color & Chemicals Mfg. Co., Ltd.) as a resin material was put, and then 31.775 g of pure water was added to dilute the resin material. 7.143 g of the MXene-aqueous dispersion (MXene particles: solid concentration 84 mg/mL) prepared as described above was added to the diluted resin material to make a total amount of 40.00 g. Thereafter, the mixture was shaken and stirred for 15 minutes using an automatic shaker (SK550 1.1, manufactured by FAST & Fluid, Inc.) to prepare a liquid composition containing MXene particles and a resin material.

A composite material membrane was obtained in the same manner as in Example 1 except that the obtained liquid composition was used.

The mass ratio between the MXene particles and the solid content of the resin material in the composite material membrane may be considered to be 95% by mass: 5% by mass from the composition of the liquid composition used.

### Example 3

### Formation of Membrane (Composite Material Membrane)

A liquid composition containing MXene particles and a resin material was prepared in the same manner as in Example 1.

The obtained liquid composition was subjected to suction filtration overnight using Nutsche. As a filter for suction filtration, a membrane filter (Durapore, manufactured by Merck KGaA, pore size 0.45 μm) was used. After suction filtration, the precursor membrane on the filter was dried in a vacuum oven at 80° C. overnight to obtain a composite material membrane.

The mass ratio between the MXene particles and the solid content of the resin material in the composite material membrane is the same as that in Example 1 from the composition of the liquid composition used.

### Comparative Example 5

### Formation of Membrane (MXene Simple Substance Material Membrane)

A liquid composition containing MXene particles and not containing a resin material was prepared in the same manner as in Comparative Example 1.

A MXene simple substance material membrane was obtained in the same manner as in Example 3 except that the obtained liquid composition was used.

### Comparative Example 6

### Formation of Membrane (Composite Material Membrane)

A liquid composition containing MXene particles and a resin material was prepared in the same manner as in Comparative Example 2.

A composite material membrane was obtained in the same manner as in Example 3 except that the obtained liquid composition was used.

The mass ratio between the MXene particles and the solid content of the resin material in the composite material membrane is the same as that in Comparative Example 2 from the composition of the liquid composition used.

### Comparative Example 7

A MXene-aqueous dispersion (MXene particles: solid concentration 34 mg/mL) was prepared in the same manner as in Example 1.

In a 50 mL centrifuge tube, 0.099 g of an PVA-containing resin material (ARON (registered trademark) AS-2000, manufactured by Toagosei Co., Ltd.) as a resin material was put, and then 22.254 g of pure water was added to dilute the resin material. 17.647 g of the MXene-aqueous dispersion (MXene particles: solid concentration 34 mg/mL) prepared as described above was added to the diluted resin material to make a total amount of 40.00 g. Thereafter, the mixture was shaken and stirred for 15 minutes using an automatic shaker (SK550 1.1, manufactured by FAST & Fluid, Inc.) to prepare a liquid composition containing MXene particles and a resin material.

In the obtained liquid composition, MXene particles were aggregated, and a membrane could not be formed.

### Comparative Example 8

A MXene-aqueous dispersion (MXene particles: solid concentration 84 mg/mL) was prepared in the same manner as in Example 2.

In a 50 mL centrifuge tube, 0.099 g of an PVA-containing resin material (ARON (registered trademark) AS-2000, manufactured by Toagosei Co., Ltd.) as a resin material was put, and then 32.758 g of pure water was added to dilute the resin material. 7.142 g of the MXene-aqueous dispersion (MXene particles: solid concentration 84 mg/mL) prepared as described above was added to the diluted resin material to make a total amount of 40.00 g. Thereafter, the mixture was shaken and stirred for 15 minutes using an automatic shaker (SK550 1.1, manufactured by FAST & Fluid, Inc.) to prepare a liquid composition containing MXene particles and a resin material.

In the obtained liquid composition, MXene particles were aggregated, and a membrane could not be formed.

The outline of the method for producing MXene particles, the type or presence or absence of the resin material, and the membrane forming method in Examples 1 to 3 and Comparative Examples 1 to 8 is summarized in Table 1.

TABLE 1

| | Method for | | |
|---|---|---|---|
| | producing | | |
| | MXene | Resin | Membrane |
| | particles | material | formation |
| Example 1 | ACID method | ARON NW-400 | Spray |
| Comparative | ACID method | None | Spray |
| Example 1 | | | |
| Comparative | ACID method | RESAMINE D-4090 | Spray |
| Example 2 | | | |
| Example 2 | MILD method | ARON NW-400 | Spray |
| Comparative | MILD method | None | Spray |
| Example 3 | | | |
| Comparative | MILD method | RESAMINE D-4090 | Spray |
| Example 4 | | | |
| Example 3 | ACID method | ARON NW-400 | Suction filtration |
| Comparative | ACID method | None | Suction filtration |
| Example 5 | | | |
| Comparative | ACID method | RESAMINE D-4090 | Suction filtration |
| Example 6 | | | |
| Comparative | ACID method | ARON AS-2000 | Impossible |
| Example 7 | | | |
| Comparative | MILD method | ARON AS-2000 | Impossible |
| Example 8 | | | |

ARON NW-400: An anionic resin material (self-crosslinking type) which contains an anionic acrylic polymer having at least one of a carboxylic acid group and a carboxylic acid salt group and having no NH group, contains tetraethylene glycol as a surfactant, and does not contain PVA.

RESAMINE D-4090: Anionic resin material containing polyurethane polymer

ARON AS-2000: Resin material (non-reactive type) containing an anionic acrylic (acrylic acid-based) polymer and PVA

For Examples 1 to 3 and Comparative Examples 1 to 6 in which a membrane could be formed, the moisture resistance of the membrane (composite material membrane in Examples 1 to 3 and Comparative Examples 2, 4, and 6, and MXene simple substance material membrane in Comparative Examples 1, 3, and 5) was evaluated as follows. In addition, regarding Examples 1 and 2 and Comparative Examples 1 to 4, the adhesion to the substrate (glass substrate) was evaluated as follows. In Example 3 and Comparative Example 5 and 6, a membrane was prepared on a membrane filter by suction filtration, and the membrane filter was removed, and the membrane filter can be used as only a membrane (self-standing film), and therefore the adhesion was not evaluated.

### Evaluation

### Moisture Resistance (High Temperature and High Humidity Test)

For the membranes (samples) prepared on the substrate in each of Examples 1 to 3and Comparative Examples 1 to 6, after preparation, the membranes were stored in a thermo-hygrostat at a temperature of 60° C. and a relative humidity of 85%, and the conductivity (S/cm) of the conductive membrane was measured after one day from the start of storage and after an appropriate number of days. More specifically, as the conductivity, the resistivity (surface resistivity) ((2) was measured at three locations per sample, the conductivity (S/cm) was calculated from the measured value of the resistivity and the thickness (μm) of the membrane measured in advance, and the arithmetic average value of the conductivities at the three locations thus obtained was adopted. For resistivity measurement, a low resistivity meter (Loresta AX MCP-T370, manufactured by Mitsubishi Chemical Analytech Co. Ltd.) was used. For the thickness measurement, the thickness (μm) of the membrane was measured immediately before the membrane was placed in a thermo-hygrostat using a stylus type surface shape measuring apparatus (DEKTAK8, manufactured by Bruker Japan K.K.), and this measurement value was used for calculating the conductivity.

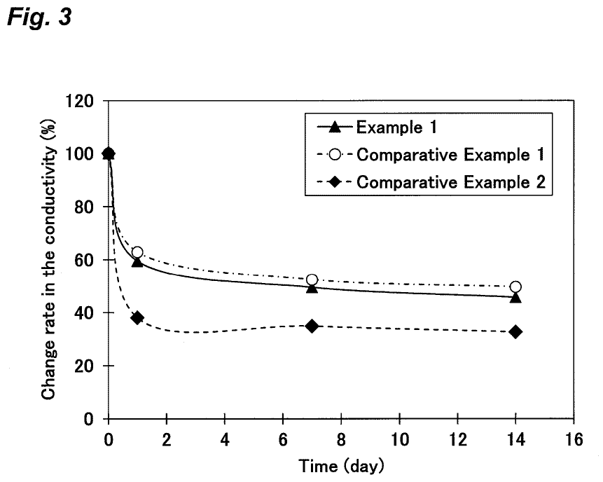

The change rate in the conductivity was determined by setting the conductivity immediately before (at the initial stage of) putting the membrane in the thermo-hygrostat to 100%. The results are illustrated in FIGS. 3 to 5. The conductivity immediately before (at the initial stage of) putting the membrane in the thermo-hygrostat and the conductivity after one day were as shown in Table 2.

TABLE 2

Conductivity (S/cm)

| | Initial stage | After one day |
|---|---|---|
| Example 1 | 11064 | 6590 (60%) |
| Comparative Example 1 | 14939 | 9406 (63%) |
| Comparative Example 2 | 7134 | 2714 (38%) |
| Example 2 | 3628 | 2023 (56%) |
| Comparative Example 3 | 3837 | 2442 (64%) |
| Comparative Example 4 | 3572 | 1450 (41%) |
| Example 3 | 6318 | 3410 (54%) |
| Comparative Example 5 | 9389 | 4659 (50%) |
| Comparative Example 6 | 4298 | 1655 (39%) |

In the evaluation of the conductivity, Comparative Examples 1, 3, and 5, which do not contain a resin material, are understood as controls.

Referring to Table 1 and FIG. 3, in Example 1 and Comparative Examples 1 and 2, a membrane was formed by spraying using MXene particles prepared by an ACID method. The conductivity was measured after 7 days and 14 days in addition to the initial stage and after one day, and the change rate in the conductivity was examined. In Comparative Example 1 (control), the change rate in the conductivity after 14 days was −50%. It is considered that the MXene particles themselves had a hydroxyl group, Li intercalated with the MXene particles attracted water molecules, and the like, thereby absorbing water, and the conductivity was reduced. In Example 1, the change rate in the conductivity after 14 days was −54%. A reduction width of Example 1 was equivalent to that of Comparative Example 1. On the other hand, in Comparative Example 2, the change rate in the conductivity after 14 days was −67%. The reduction width in Comparative Example 2 was significantly larger than the reduction width in Comparative Example 1 and Example 1.

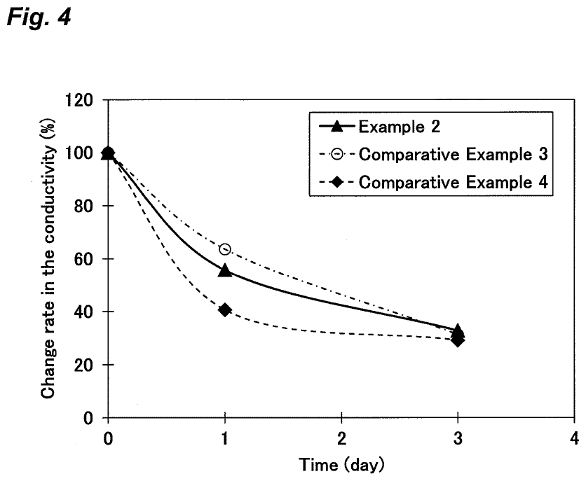

Referring to Table 1 and FIG. 4, in Example 2 and Comparative Examples 3 and 4, a membrane was formed by spraying using MXene particles produced by the MILD method. The conductivity was measured after 3 days in addition to the initial stage and after one day, and the change rate in the conductivity was examined. In Comparative Example 3 (control), the change rate in the conductivity was −36% after one day and −69% after 3 days. In Example 2, the change rate in the conductivity was −44% after one day and −67% after 3 days. The reduction width of Example 2 was equivalent to that of Comparative Example 3. On the other hand, in Comparative Example 4, the change rate in the conductivity was −59% after one day and −71% after 3 days. The reduction width in Comparative Example 4 was significantly larger than the reduction width in Comparative Example 3 and Example 2 particularly after one day.

Comparing Example 1 (ACID method) in FIG. 3 with Example 2 (MILD method) in FIG. 4, it is understood that use of MXene particles produced by the ACID method is more preferable than use of MXene particles produced by the MILD method because higher moisture resistance can be obtained. It is considered that the MXene particles produced by the ACID method have lower hygroscopicity than the MXene particles produced by the MILD method, and the effect of using the anionic resin material in the present disclosure is easily exhibited. It is considered that moisture absorption by the MXene particles occurs by attracting water molecules to a hydroxyl group or intercalated Li on the surface of the MXene particles. It is presumed that the MXene particles differ in the amount of surface functional groups and Li depending on the etching method (ACID method or MILD method).

Therefore, it is considered that the MXene particles produced by the ACID method and the MXene particles produced by the MILD method have different amounts of surface functional groups and Li, and accordingly have different hygroscopicity.

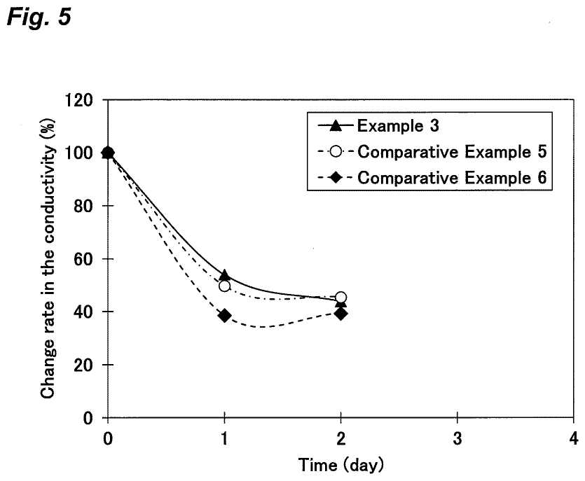

Referring to Table 1 and FIG. 5, in Example 3 and Comparative Examples 5 and 6, a membrane was formed by suction filtration using MXene particles prepared by an ACID method. The conductivity was measured after 2 days in addition to the initial stage and after one day, and the change rate in the conductivity was examined. In Comparative Example 5(control), the change rate in the conductivity was −50% after one day and −55% after 2 days. In Example 2, the change rate in the conductivity was −46% after one day and −56% after 2 days. The reduction width of Example 3 was equivalent to that of Comparative Example 5. On the other hand, in Comparative Example 6, the change rate in conductivity was −61% after one day and −61% after 2 days. The reduction width of Comparative Example 6 was significantly larger than the reduction widths of Comparative Example 5 and Example 3 particularly after one day.

Comparing Example 1 (spray) of FIG. 3 with Example 3 (suction filtration) of FIG. 5, it is understood that a membrane formed by spraying is more preferable than a membrane formed by suction filtration because higher moisture resistance can be obtained. It is considered that the membrane formed by spraying has a higher density (less voids) than the membrane formed by suction filtration, and the effect of using the anionic resin material in the present disclosure is easily exhibited. On the other hand, it is considered that the membrane formed by suction filtration tends to have a sparse structure.
Adhesion (tape peeling test)

The adhesion (bonding strength) of a membrane (sample not subjected to moisture resistance evaluation) produced on the substrate (glass substrate) in each of Examples 1 and 2and Comparative Examples 1 to 4 to the substrate was evaluated in accordance with the cross-cut method defined in JIS K5600-5-6. The evaluation results are classified as follows. The results are shown in Table 3.
0: Edges of cut are perfectly smooth and there is no peeling in any grid.
1: Small peeling of coating at intersection of cuts. Cross-cut portion is not clearly affected more than 5%.
2: Coating has peeled off along edges of cuts and/or at intersections. Cross-cut portion is clearly affected by more than 5% but not more than 15%.
3: Coating has largely peeled off partially or entirely along edges of cuts, and/or various parts of the eye are peeled off partially or entirely. Cross-cut portion is clearly affected by more than 15% but not more than 35%.
4: Coating has largely peeled off partially or entirely along edges of cuts, and/or several eyes are peeled off partially or entirely. Cross-cut portion is not clearly affected more than 65%.
5: Any one of cases where classification cannot be performed even in classification 4.

TABLE 3

| | Evaluation of tape peeling test |
|---|---|
| Example 1 | 0 |
| Comparative Example 1 | 4 |
| Comparative Example 2 | 0 |
| Example 2 | 3 |
| Comparative Example 3 | 5 |
| Comparative Example 4 | 4 |

With reference to Table 3, among Example 1 and Comparative Examples 1 and 2 in which membranes were formed by spraying using MXene particles prepared by the ACID method, the membranes of Example 1 and Comparative Example 2 were evaluated as 0, and the evaluation values were smaller than that of Evaluation of the membrane of Comparative Example 1 as 4. In Example 1 and Comparative Example 2, a composite material membrane containing MXene particles and a resin material was formed, and it is considered that adhesion was secured by mixing the resin material. On the other hand, in Comparative Example 1, since the MXene simple substance material membrane was formed and the resin material was not mixed, it is considered that adhesion could not be secured.

Among Example 2 and Comparative Examples 3 and 4 in which membranes were formed by spraying using MXene particles prepared by the MILD method, the membranes of Example 2 and Comparative Example 4 were evaluated as 3 and 4, respectively, which were smaller in evaluation value than Evaluation of the membrane of Comparative Example 3 as 5. It is considered that in Example 2 and Comparative Example 4, a composite material membrane containing MXene particles and a resin material was formed, and by mixing the resin material, the adhesion was improved as compared with Comparative Example 4 in which the resin material was not mixed.

Comparing Example 1 (ACID method) with Example 2 (MILD method), it is understood that use of MXene particles produced by the ACID method is more preferable than use of MXene particles produced by the MILD method because higher adhesion can be obtained. As described above, it is considered that the MXene particles produced by the ACID method and the MXene particles produced by the MILD method have different amounts of surface functional groups and Li, and accordingly have different adhesion.

The composite material of the present disclosure can be used in any suitable application, and can be preferably used, for example, as electrodes or electromagnetic shield in electrical devices.

### REFERENCES NUMERALS

1a, 1b Layer body (MₘXₙ layer)
3a, 5a, 3b, 5b Modifier or terminal T
7a, 7b MXene layer
10, 10a, 10b MXene particles (particles of two-dimensional material)
11 Anionic resin material
20 Composite material (composite material structure)

1. A composite material, comprising:
particles of a two-dimensional material comprising one or plural layers; and
an anionic resin material comprising an anionic polymer having at least one of a carboxylic acid group and a carboxylic acid salt group and having no NH group, and excluding a resin material containing polyvinyl alcohol,
wherein the one or plural layers comprises a layer body represented by:
MₘXₙ
wherein M is at least one metal of Group 3, 4, 5, 6, or 7, X is a carbon atom, a nitrogen atom, or a combination thereof, n is not less than 1 and not more than 4,and m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom, and
wherein a ratio of the particles of the two-dimensional material to a total of the particles of the two-dimensional material and a solid content of the anionic resin material in the composite material is not less than 50% by mass and not more than 99.9% by mass.

2. The composite material according to claim 1, and constructed in a form of a structure body.

3. The composite material according to claim 2, wherein the structure body is a membrane.

4. The composite material according to claim 1, wherein the anionic resin material is an acrylic resin material.

5. The composite material according to claim 1, wherein the MₘXₙ is Ti₃C₂.

6. A composite material, comprising:
particles of a two-dimensional material comprising one or plural layers; and
an anionic resin material comprising an anionic polymer having at least one of a carboxylic acid group and a carboxylic acid salt group and having no NH group, and excluding a resin material containing polyvinyl alcohol, and wherein the anionic resin material is a self-crosslinking resin material,
wherein the one or plural layers comprises a layer body represented by:
MₘXₙ
wherein M is at least one metal of Group 3, 4, 5, 6, or 7, X is a carbon atom, a nitrogen atom, or a combination thereof, n is not less than 1 and not more than 4, and m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom.

7. The composite material according to claim 6, wherein the anionic resin material is an acrylic resin material.

8. The composite material according to claim 6, wherein the MₘXₙ is Ti₃C₂.

9. The composite material according to claim 6, wherein a ratio of the particles of the two-dimensional material to a total of the particles of the two-dimensional material and a solid content of the anionic resin material in the composite material is not less than 50% by mass and not more than 99.9% by mass.

10. A method for producing a composite material structure body, the method comprising:
(a) preparing a liquid composition containing particles of a two-dimensional material comprising one or plural layers, a resin material, and a liquid medium, the one or plural layers comprising a layer body represented by:
MₘXₙ
wherein M is at least one metal of Group 3, 4, 5, 6, or 7, X is a carbon atom, a nitrogen atom, or a combination thereof, n is not less than 1and not more than 4, and m is more than n but not more than 5, and
a modifier or terminal T existing on a surface of the layer body, wherein T is at least one selected from the group consisting of a hydroxyl group, a fluorine atom, a chlorine atom, an oxygen atom, and a hydrogen atom, and
wherein the resin material is an anionic resin material containing an anionic polymer having at least one of a carboxylic acid group and a carboxylic acid salt group and having no NH group, and excluding a resin material containing polyvinyl alcohol; and
(b) forming a precursor structure body on a substrate using the liquid composition, and at least drying the precursor structure body to obtain a composite material structure body,
wherein a ratio of the particles of the two-dimensional material to a total of the particles of the two-dimensional material and a solid content of the resin material in the composite material is not less than 50% by mass and not more than 99.9% by mass.

11. The method for producing a composite material structure body according to claim 10, wherein the composite material structure body is a composite material membrane.

12. The method for producing a composite material structure body according to claim 10, wherein the resin material is an acrylic resin material.

13. The method for producing a composite material structure body according to claim 10, wherein in the (a), a ratio of the solid content of the resin material to a total of the particles of the two-dimensional material and the solid content of the resin material in the liquid composition is not less than 0.1% by mass and not more than 99.9% by mass.

14. The method for producing a composite material structure body according to claim 10, further comprising: before the (a),
etching a raw material represented by:
MₘXₙ
wherein A is at least one of Group 12, 13, 14, 15, and 16 elements, with an etching solution containing hydrofluoric acid to obtain the particles of the two-dimensional material.

15. The method for producing a composite material structure body according to claim 10, further comprising: before the (a),
etching a raw material represented by:
MₘXₙ
wherein A is at least one of Group 12, 13, 14, 15, and 16 elements, with an etching solution containing fluoride and acid, and excluding hydrofluoric acid, to obtain the particles of the two-dimensional material.

16. The method for producing a composite material structure body according to claims 10, wherein the precursor structure body is formed by spraying the liquid composition onto the substrate in the (b).

17. The method for producing a composite material structure body according to claim 10, wherein the MₘXₙ is Ti₃C₂.

18. A method for producing a composite material structure body, the method comprising:
(a) preparing a liquid composition containing particles of a two-dimensional material comprising one or plural layers, a resin material, and a liquid medium, the one or plural layers comprising a layer body represented by:
MₘXₙ
wherein M is at least one metal of Group 3, 4, 5, 6, or 7, X is a carbon atom, a nitrogen atom, or a combination thereof, n is not less than 1 and not more than 4, and m is more than n but not more than 5, and a modifier or terminal T existing on a surface of the layer body,
wherein T is at least one selected from the group consisting of a hydroxyl group, a fluorine atom, a chlorine atom, an oxygen atom, and a hydrogen atom, and
wherein the resin material is an anionic resin material containing an anionic polymer having at least one of a carboxylic acid group and a carboxylic acid salt group and having no NH group, and excluding a resin material containing polyvinyl alcohol, and the resin material is a self-crosslinking resin material; and
(b) forming a precursor structure body on a substrate using the liquid composition, and at least drying the precursor structure body to obtain a composite material structure body.

19. The method for producing a composite material structure body according to claim 18, further comprising: before the (a),
etching a raw material represented by:
MₘXₙ
wherein A is at least one of Group 12, 13, 14, 15, and 16 elements, with an etching solution containing hydrofluoric acid to obtain the particles of the two-dimensional material.

20. The method for producing a composite material structure body according to claim 18, further comprising: before the (a),
etching a raw material represented by:
MₘXₙ
wherein A is at least one of Group 12, 13, 14, 15, and 16 elements, with an etching solution containing fluoride and acid, and excluding hydrofluoric acid, to obtain the particles of the two-dimensional material.
